(19) United States
(12) Patent Application Publication
(10) Pub. No.: US 2007/0088134 A1
(43) Pub. Date: Apr. 19, 2007

(54) Thermosetting resin composition containing modified polyimide resin

(75) Inventors: Akihisa Suzuki, Kawasaki-shi (JP); Hiroshi Orikabe, Kawasaki-shi (JP); Tadahiko Yokota, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 11/248,222

(22) Filed: Oct. 13, 2005

(51) Int. Cl. C08L 77/06; C08G 18/65

(52) U.S. Cl. 525/421; 525/123; 525/424; 525/430; 525/426

(57) ABSTRACT

Thermosetting resin compositions which comprise: (A) at least one modified linear polyimide resin obtained by reacting a bifunctional hydroxyl-terminated polybutadiene, a diisocyanate compound, and a tetracarboxylic acid anhydride, and (B) at least one thermosetting resin selected from the group consisting of an epoxy resin, a bismaleimide resin, a cyanate ester resin, a bis-allyl-nadi-imide resin, a vinylbenzyl ether resin, a benzooxazine resin, a polymer of bismaleimide and diamine, and mixtures thereof, are useful as insulating materials for a flexible circuit boards and can readily have a conductor layer with excellent adhesion strength formed thereon by plating.

### BACKGROUND OF THE INVENTION

1. Field of the Invention

The present invention relates to thermosetting resin compositions which are suitable for a flexible circuit board. The present invention also relates to flexible circuit boards, adhesive films, and films for a flexible circuit board produced with such a thermosetting resin composition. The invention further relates to flexible circuit boards and the like produced by using the thermosetting resin composition, the adhesive film or the film for a flexible circuit board.

2. Discussion of the Background

The demand for thinner lightweight semiconductor parts with high packing densities has increased in recent years. In an effort to satisfy this demand, attention has been paid to the use of flexible circuit boards as substrate boards of the semiconductor parts. The flexible circuit boards can have smaller thickness and lighter weight as compared with rigid circuit boards, and because of their features of flexibility and deformability, they can be bended and packed. Thus, the flexible circuit boards are advantageous in high-density IC packaging and module downsizing, and have been used in TCP (Tape Carrier Package), COF (Chip On Film) and the like, so that they have been essential for miniaturization of various media apparatuses.

The flexible circuit boards are generally produced by forming a three-layer film that is composed of a polyimide film, a copper foil, and an adhesive, or a two-layer film that is composed of a polyimide film and a conductor layer, followed by having the conductor layer etched to form a circuit according to a subtractive process. Although the three-layer films which can be produced with relatively low cost have been used more commonly as the film, two-layer films are gaining popularity in use for circuit boards with high-density wirings, because the adhesive has disadvantages of heat resistance and electrical insulation.

The two-layer films are classified into three types, i.e., sputter type, cast type, and laminate type, named according to the production methods. The cast type films are produced by coating a polyamic acid varnish on a rolled or electrodeposited copper foil and by thermally imidating the same. The laminate type films are produced by bonding a copper foil and a polyimide film with a thermoplastic polyimide (see, for example, JP-A-4-33847 and JP-A-4-33848). The sputter type films are produced by forming a thin conductor layer on a polyimide film by sputtering, followed by thickening of the conductor layer by subjecting the sputtered layer to electroplating (see, for example, JP-A-2-98994).

When a conductor layer is formed with a copper foil, circuit formation is generally executed by a subtractive process. In this instance, it is important to reduce the thickness of the conductor layer to form a fine pitch wiring. However, it is difficult from the perspective of handling in the production step to use an ultrathin copper foil, which for instance has a thickness of less than 12 μm, in production of the three-layer films, the cast type two-layer films, and the laminate type two-layer films which are produced using a copper foil. In attempts to overcome the copper foil handling problems, a method in which an ultrathin copper foil having a peelable support film is used, a method in which a three- or two-layer film is prepared using a thick copper foil and subsequently the thickness of the conductor layer is reduced by half etching, or the like has been performed, however, these methods are costly and not always preferred.

The sputter type two-layer films prepared by electroplating are suitable for forming a fine pitch wiring, because a thin conductor layer can be formed relatively easily. However, the sputtering process requires an expensive and precision vacuum apparatus, and therefore, these films are disadvantageous in cost and productivity.

Meanwhile, a method of chemically roughening an insulating layer and forming a conductor layer thereon by electroless plating and electroplating has been widely employed in the production of the rigid circuit boards. This method can achieve high productivity, and the flexible circuit boards having a fine pitch wiring can be more readily produced when the method can be utilized for an insulating material, such as a polyimide, used in the flexible circuit board.

In the production of double-sided or multi-layered flexible circuit boards, a through hole is formed to achieve conduction between layers. To this end, a laser has been widely used to form the through hole. However, when the conductor layer is introduced with the copper foil, a part of the conductor layer corresponding to a portion to be laser-processed must be removed by etching beforehand, whereby complicated processes are required. Where the conductor layer can be formed by the electroless plating and electroplating, the production step can be simplified through forming the conductor layer after the laser processing.

However, according to conventional insulating materials for flexible circuit boards such as polyimide, it is difficult to form a conductor layer with sufficient adhesion strength by plating on an insulating layer after chemical roughening, and it is also difficult to form a multilayer structure. Therefore, it has been desired to develop an insulating material for the flexible circuit boards, on which formation of a conductor layer that is excellent in adhesion strength can be readily effected by plating.

On the other hand, such a material, which is flexible and can be plated by a simple method, is useful also for semiconductor parts using rigid circuit boards. Connecting a substrate board and a semiconductor provides the semiconductor parts. The board and the semiconductor have greatly different thermal expansion coefficients, whereby the connection portion is often stressed by heat to cause problems such as poor connection. Thus, much attention has been paid to the use of a high-flexible insulating material as a stress relaxation material between the semiconductor and the substrate board. Currently used stress relaxation materials for the semiconductor parts include silicon rubber-based materials (see, JP-A-2000-336271) and porous fluorine resin-based sheet materials. However, it is difficult to form the conductor layer having sufficient adhesion strength on these materials by electroless and electroplating after the chemical roughening.

JP-A-11-199669 discloses a polyimide resin having a polybutadiene skeleton, and further discloses an illustrative example of a resin composition prepared by combining the polyimide resin with a polybutadiene polyol and a polyblocked isocyanate, which is usefull as an overcoat material for a flexible circuit.

JP-A-11-246760 discloses a resin prepared by combining a polyamideimide resin having a polybutadiene skeleton and a polysiloxane skeleton, and an epoxy resin, and describes that the resin may be suitably used in overcoating materials for electronic parts, liquid sealants, varnishes for enamel wires, impregnating varnishes for electric insulation, casting varnishes, varnishes for sheets in combination with a base material such as mica or a glass cloth, varnishes for MCL laminated plates, varnishes for friction materials, surface protective films, solder resist layers, adhesive layers, interlayer insulation films in fields of print boards, and the like, and electronic parts such as semiconductor elements. However, the polysiloxane resin which may be used as a material of the polyamideimide resin generally contains a low molecular siloxane component having a high volatility. Therefore, the component volatilizes in the steps of drying and thermal hardening, thereby making the surface of the print wiring plates and the like dirty to often result in defects such as adhesive failure of the sealant resins and the like. Additionally, because a carboxylic acid-terminated polybutadiene compound is used as a starting material, a reaction at high temperature is required. Thus, oxidation of the butadiene skeleton may cause intramolecular crosslinking, leading to the possibility of gelation of the resin. Accordingly, more advanced control of the reaction is required.

JP-A-2003-292575 discloses a resin composition prepared by combining an epoxy resin and a polyimide resin having a polybutadiene skeleton, as a thermosetting resin composition that is useful in fields of build up materials, interlayer insulating materials for print wiring boards, heat resistant adhesives, insulating materials for semiconductors, and the like. The polyimide resin described in JP-A-2003-292575 has an isocyanurate ring in the molecular skeleton, thereby providing a branched structure. Therefore, the hardened material thereof has many crosslinked points to lead to difficulty in obtaining a hardened material with low elasticity. In addition, because the content of the polybutadiene structure in the polyimide is low, the elastic modulus of the hardened material tends to be high. Thus, it is not satisfactory in view of flexibility. Also, as is clear from the Examples, the polyimide resin hardened material has a breaking extension of 15% or less, which can not be sufficient also in view of the folding endurance.

Thus, there remains a need for thermosetting resin compositions which are suitable for use in flexible circuit boards which are free of the above-described drawbacks.

### SUMMARY OF THE INVENTION

Accordingly, it is one object of the present invention to provide novel thermosetting resin compositions.

It is another object of the present invention to provide novel thermosetting resin compositions, which are usefull as insulating materials for a flexible circuit board and a semiconductor apparatus.

It is another object of the present invention to provide novel thermosetting resin compositions, which are excellent in flexibility and folding endurance.

It is another object of the present invention to provide novel thermosetting resin compositions on which a conductor layer with excellent adhesion strength can be easily form by plating.

These and other objects, which will become apparent during the following detailed description, have been achieved by the inventors' discovery that a thermosetting resin composition, which contains a particular modified linear polyimide resin obtained by reacting three components of a bifunctional hydroxyl-terminated polybutadiene, a diisocyanate compound, and a tetrabasic acid dianhydride, and a particular thermosetting resin, is excellent in flexibility, mechanical strength and dielectric properties, and is suitable for forming an insulating layer of flexible circuit boards and the like. Further, the present inventors have found that this thermosetting resin composition can be thermally hardened to form a hardened material, on which surface plating can easily form a conductor layer with excellent adhesiveness.

Accordingly, the present invention provides the following:

(1) A thermosetting resin composition, comprising:

(A) at least one modified linear polyimide resin obtained by reacting a bifunctional hydroxyl-terminated polybutadiene, a diisocyanate compound, and a tetracarboxylic acid anhydride; and

(B) at least one thermosetting resin selected from the group consisting of an epoxy resin, a bismaleimide resin, a cyanate ester resin, a bis-allyl-nadi-imide resin, a vinylbenzyl ether resin, a benzooxazine resin, a polymer of bismaleimide and diamine, and mixtures thereof.

(2) The thermosetting resin according to the above item (1), wherein the modified linear polyimide resin of the component (A) is a modified linear polyimide resin obtained by reacting a bifunctional hydroxyl-terminated polybutadiene and a diisocyanate compound such that the functional group equivalent ratio of the isocyanate groups of the diisocyanate compound to the hydroxyl groups of the bifunctional hydroxyl-terminated polybutadiene is greater than 1 to prepare a polybutadiene diisocyanate composition and by reacting the polybutadiene diisocyanate composition with a tetracarboxylic acid dianhydride.

(3) The thermosetting resin composition according to the above item (1), wherein the modified linear polyimide resin of the component (A) is a modified linear polyimide resin obtained by reacting a bifunctional hydroxyl-terminated polybutadiene and a diisocyanate compound such that the functional group equivalent ratio of the isocyanate groups of the diisocyanate compound to the hydroxyl groups of the bifunctional hydroxyl-terminated polybutadiene is 1:1.5 to 1:2.5 to prepare a polybutadiene diisocyanate composition and by reacting the polybutadiene diisocyanate composition with a tetracarboxylic acid dianhydride.

(4) The thermosetting resin composition according to the above item (1), wherein the modified linear polyimide resin of the component (A) is a modified linear polyimide resin obtained by reacting a bifunctional hydroxyl-terminated polybutadiene and a diisocyanate compound such that the functional group equivalent ratio of the isocyanate groups of the diisocyanate compound to the hydroxyl groups of the bifunctional hydroxyl-terminated polybutadiene is 1:1.5 to 1:2.5 to prepare a polybutadiene diisocyanate composition and by reacting the polybutadiene diisocyanate composition with a tetracarboxylic acid dianhydride at a ratio which allows the functional group equivalent X of the isocyanate groups of the starting material diisocyanate compound, the functional group equivalent W of the hydroxyl groups of the starting material bifunctional hydroxyl-terminated polybutadiene, and the functional group equivalent Y of the acid anhydride groups of the tetracarboxylic acid dianhydride to satisfy the relation of Y>X—W≧Y/5 (W>0, X>0, Y>0).

(5) The thermosetting resin composition according to any one of the above items (1) to (4), wherein the modified linear polyimide resin of the component (A) is a modified linear polyimide resin obtained by further reacting an additional isocyanate compound and the modified linear polyimide resin according to any one of the above items (1) to (4) at a ratio which allows the functional group equivalent X of the isocyanate groups of the starting material diisocyanate compound, the functional group equivalent W of the hydroxyl groups of the starting material bifunctional hydroxyl-terminated polybutadiene, the functional group equivalent Y of the acid anhydride groups of the tetracarboxylic acid dianhydride, and the functional group equivalent Z of isocyanate groups of the newly reacted isocyanate compound to satisfy the relation of Y—(X—W)>Z≧0 (W>0, X>0, Y>0, Z>0). 6) A thermosetting resin composition comprising:

(A) a modified linear polyimide resin having a polybutadiene structure represented by the following formula (1-a) and a polyimide structure represented by the following formula (1-b) within a molecule:

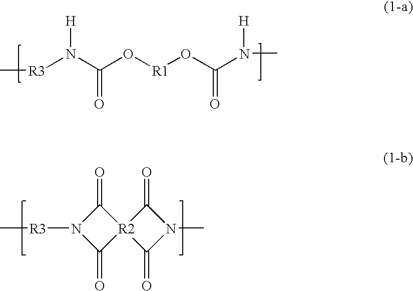

wherein R1 represents a residue obtained by removing hydroxyl groups from a bifunctional hydroxyl-terminated polybutadiene; R2 represents a residue obtained by removing acid anhydride groups from a tetracarboxylc acid dianhydride; and R3 represents a residue obtained by removing isocyanate groups from a diisocyanate compound, and

(B) a at least one thermosetting resin selected from the group consisting of an epoxy resin, a bismaleimide resin, a cyanate ester resin, a bis-allyl-nadi-imide resin, a vinylbenzyl ether resin, a benzooxazine resin, a polymer of bismaleimide and diamine, and mixtures thereof.

(7) The thermosetting resin composition according to any one of the above items (1) to (6), wherein the content of the polybutadiene structure in the modified linear polyimide resin of the component (A) is 45% by weight or more.

(8) The thermosetting resin composition according to any one of the above items (1) to (6), wherein the content of the polybutadiene structure in the modified linear polyimide resin of the component (A) is 60% by weight or more.

(9) The thermosetting resin composition according to any one of the above items (1) to (8), wherein R1 represents a residue obtained by removing hydroxyl groups from a bifunctional hydroxyl-terminated polybutadiene having a number average molecular weight of 800 to 10000.

(10) The thermosetting resin composition according to any one of the above items (1) to (9), wherein a hardened material of the thermosetting resin composition has an elastic modulus of 100 MPa or less, and a breaking extension of 20% or more.

(11) The thermosetting resin composition according to any one of the above items (1) to (10), wherein the composition ratio of the component (A) and the component (B) is 100:1 to 1:1 by weight, and the total content of the component (A) and the component (B) in the thermosetting resin composition is 70% by weight or more.

(12) The thermosetting resin composition according to any one of the above items (1) to (11) which further comprises a filler.

(13) The thermosetting resin composition according to any one of the above items (1) to (12), wherein the thermosetting resin of the component (B) is an epoxy resin.

(14) The thermosetting resin composition according to the above item (13) which further comprises an epoxy curing agent.

(15) An adhesive film, comprising a thermosetting resin composition layer (layer A) which comprises a thermosetting resin composition according to any one of the above items (1) to (14) formed on a support film (layer B).

(16) An adhesive film comprising a thermosetting resin composition layer (layer A) which comprises a thermosetting resin composition according to any one of the above items (1) to (14) formed on a release-treated surface of a support film subjected to a release treatment (layer B).

(17) A flexible circuit board comprising a circuit formed on a cured material of the thermosetting resin composition according to any one of the above items (1) to (14).

(18) A multilayer flexible circuit board produced by a method comprising the following steps (1) to (9):

(1) laminating one or both sides of a flexible circuit board with an adhesive film according to the above item (15) or (16);

(2) removing or not removing the layer B;

(3) thermally curing the layer A to form an insulating layer;

(4) removing or not removing the B layer when the B layer is not removed in the step (b);

(5) forming a hole in the flexible circuit board;

(6) removing the B layer when the B layer is not removed in the steps (2) and (4);

(7) subjecting the insulating layer to a surface treatment;

(8) forming a conductor layer by plating on the insulating layer; and

(9) forming the conductor layer into a circuit on the insulating layer.

(19) A film for a flexible circuit board comprising an insulating layer (layer A′) which comprises a cured material of a thermosetting resin composition according to any one of the above items (1) to (14) on a heat resistant resin layer (layer C).

(20) A single-sided flexible circuit board obtained by subjecting the layer A′ of the film for a flexible circuit board according to the above item (19) to a surface treatment, forming a conductor layer by plating on the insulating layer, and forming the conductor layer into a circuit.

(21) A film for a flexible circuit board comprising an insulating layer (layer A′) which comprises a cured material of a thermosetting resin composition according to any one of the above items (1) to (14), a heat resistant resin layer (layer C) and a copper foil (layer D), wherein the film has a layered structure in the order of: layer A′, layer C, and layer D.

(22) A double-sided flexible circuit board obtained by forming a hole in the film for a flexible circuit board according to the above item (21), subjecting the layer A′ to a surface treatment, forming a conductor layer by plating on the surface of the layer A′, and forming the conductor layer and layer D into a circuit.

(23) A film for a flexible circuit board comprising an insulating layer (layer A′) which comprises a cured material of a thermosetting resin composition according to any one of the above items (1) to (14) and a heat resistant resin layer (layer C), wherein the film has a layered structure in the order of: layer A′, layer C, and layer A′.

(24) A double-sided flexible circuit board obtained by forming a hole in the film for a flexible circuit board according to the above item (23), subjecting the layer A′ to a surface treatment, forming a conductor layer by plating on the surface of the layer A′, and forming the conductor layer into a circuit.

(25) A semiconductor apparatus comprising a semiconductor and a substrate board, which are bonded with a cured material comprising a thermosetting resin composition according to any one of the above items (1) to (14).

The cured material of the thermosetting resin composition of the invention is excellent in flexibility, mechanical strength and dielectric properties, and a conductor layer with excellent adhesiveness can be easily formed on it by surface plating.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is an SEM micrograph (1,000 magnification) of the surface-treated insulating layer surface of Example 8;

FIG. 2 is an SEM micrograph (1,000 magnification) of the surface-treated insulating layer surface of Example 9;

FIG. 3 is an SEM micrograph (1,000 magnification) of the surface-treated insulating layer surface of Example 10;

FIG. 4 is an SEM micrograph (1,000 magnification) of the surface-treated insulating layer surface of Example 11; and

FIG. 5 is an SEM micrograph (1,000 magnification) of the surface-treated insulating layer surface of Comparative Example 2.

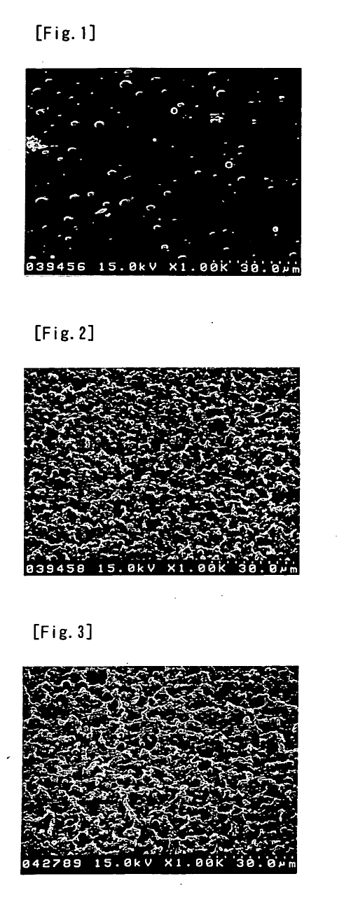

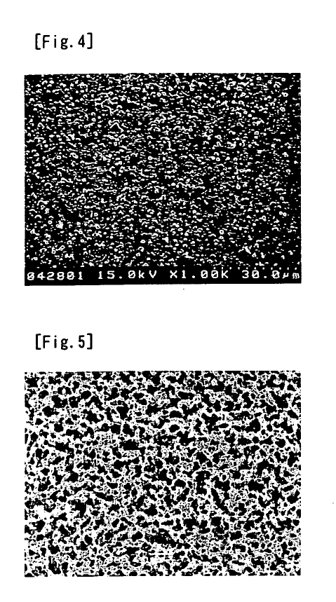

### DETAILED DESCRIPTION OF THE PREFERRED EMBODIMENTS

The present invention will be described in detail below.

In the present invention, the modified linear polyimide resin of component (A) is a modified linear polyimide resin obtained by reacting three components of:

(a) a bifunctional hydroxyl-terminated polybutadiene;

(b) a diisocyanate compound; and

(c) a tetracarboxylic acid dianhydride.

The modified linear polyimide resin may contain both of a polybutadiene structure represented by the following formula (1-a) and a polyimide structure represented by the formula (1-b) within a molecule. The content of the polybutadiene structure in the modified linear polyimide resin is preferably 45% by weight or more, and more preferably 60% by weight or more. When the content of the polybutadiene structure in the modified linear polyimide resin is less than 45% by weight, the hardened material of the thermosetting resin composition of the invention tends to be poor in flexibility. The content of the polybutadiene structure part in the modified linear polyimide resin (% by weight) can be defined as weight ratio of the bifunctional hydroxyl-terminated polybutadiene (a) to the total weight of the above three components (a) to (c) used in the reaction.

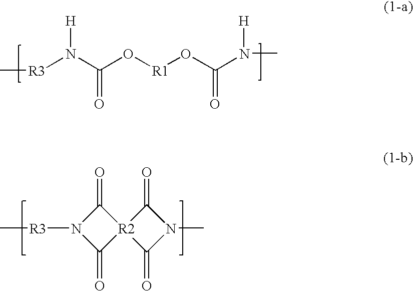

In the formulae above, R1 represents a residue provided by removing hydroxyl groups from a bifunctional hydroxyl-terminated polybutadiene; R2 represents a residue provided by removing acid anhydride groups from a tetrabasic acid dianhydride; and R3 represents a residue provided by removing isocyanate groups from a diisocyanate compound. The bifunctional hydroxyl-terminated polybutadiene preferably has a number average molecular weight of 800 to 10000. In the polybutadiene structure of the formula (1-a), R1 preferably represents a residue provided by removing hydroxyl groups from a bifunctional hydroxyl-terminated polybutadiene having a number average molecular weight of 800 to 10000. When the number average molecular weight of the bifunctional hydroxyl-terminated polybutadiene is 800 or less, the modified polyimide resin tends to be poor in flexibility. When the number average molecular weight is 10000 or more, the modified polyimide resin tends to be poor in compatibility with the thermosetting resin and also tends to be poor in heat resistance. In the present invention, number average molecular weights may be measured by a gel permeation chromatography (GPC) method with a polystyrene standard. In the GPC method, specifically, the number average molecular weights are measured by using a measuring apparatus LC-9A/RID-6A manufactured by Shimadzu Corporation, columns Shodex K-800P/K-804L/K-804L manufactured by Showa Denko K.K., and a mobile phase of chloroform at a column temperature of 40° C., and calculated by using a calibration curve of the polystyrene standard.

In the modified linear polyimide resin, the number of the polybutadiene structure (1-a) present per one molecule is generally 1 to 10,000, and preferably 1 to 100. The number of the polyimide structure (1-b) present per one molecule is generally 1 to 100, and preferably 1 to 10.

The number average molecular weight of the modified linear polyimide resin is not particularly limited, but may be generally 5000 to 200000, and preferably 10000 to 100000.

The components (a) to (c), which are starting materials for the modified linear polyimide resin, may be represented by the following formulae (a) to (c), respectively.

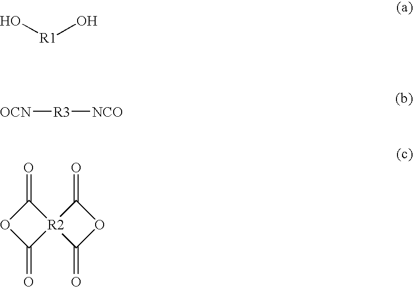

Symbols in the formulae have the same meanings as those defined above. Because the modified linear polyimide resin is synthesized from the aforementioned bifunctional monomer alone, a modified polyimide resin having a linear structure is provided. In other words, the modified linear polyimide resin according to an aspect of the invention means a modified polyimide resin having a linear structure produced using a bifunctional monomer as a starting material. Thus, the linear structure of the modified polyimide in the invention can provide a thermosetting resin composition that is more excellent in flexibility.

The following procedures are preferably employed to efficiently obtain the modified linear polyimide resin in the present invention.

First, component (a) of the polybutadiene and component (b) of the diisocyanate compound are reacted such that the functional group equivalent ratio of the isocyanate groups of the diisocyanate compound to the hydroxyl groups of the polybutadiene is greater than 1, to obtain a composition containing a polybutadiene diisocyanate. The polybutadiene diisocyanate may be represented by the following formula (a-b).

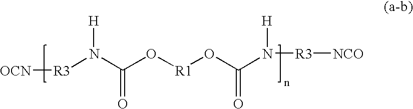

In the formula (a-b), R1 represents a residue provided by removing the hydroxyl groups from the bifunctional hydroxyl-terminated polybutadiene, R3 represents a residue provided by removing the isocyanate groups from the diisocyanate compound, and n represents an integer of 1 to 100 (1≦n≦100). n preferably represents an integer of 1 to 10 (1≦n≦10). In the polybutadiene isocyanate represented by the formula (a-b), R1 preferably represents a residue provided by removing the hydroxyl groups from the bifunctional hydroxyl-terminated polybutadiene having a number average molecular weight of 800 to 10000.

The reaction ratio between the polybutadiene and the diisocyanate compound is preferably such that the functional group equivalent ratio between the hydroxyl groups of the polybutadiene to the isocyanate groups of the diisocyanate compound is 1:1.5 to 1:2.5.

Then, the polybutadiene diisocyanate composition is reacted with the tetracarboxylic acid dianhydride. The reaction ratio of the tetracarboxylic acid dianhydride is not particularly limited, but is preferably such that the residual isocyanate groups are minimized in the composition. When X represents the functional group equivalent of the isocyanate groups of the starting material diisocyanate compound, W represents the functional group equivalent of the hydroxyl groups of the starting material bifunctional hydroxyl-terminated polybutadiene, and Y represents the functional group equivalent of the acid anhydride groups of the tetrabasic acid dianhydride, they preferably satisfy the relation of Y>X—W≧Y/5 (W>0, X>0, Y>0).

The modified linear polyimide resin thus obtained contains both of the polybutadiene structure represented by the formula (1-a) and the imide structure represented by the formula (1-b) within a molecule, as described above. The modified linear polyimide resin used in the present invention preferably comprises a modified linear polyimide having a structure represented by the following formula (a-b-c) as a main component.

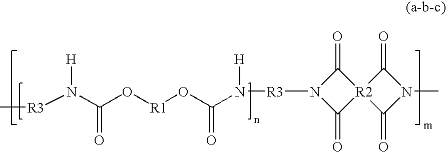

In the formula (a-b-c), R1 represents a residue provided by removing the hydroxyl groups from the bifunctional hydroxyl-terminated polybutadiene, R2 represents a residue provided by removing the acid anhydride groups from the tetracarboxylic acid dianhydride, R3 represents a residue provided by removing the isocyanate groups from the diisocyanate compound, and n and m each represent an integer of 1 to 100 (1≦n≦100). Each of n and m preferably represents an integer of 1 to 10 (1≦n≦10). In the polybutadiene isocyanate represented by the formula (a-b-c), R1 preferably represents a residue provided by removing the hydroxyl groups from the bifunctional hydroxyl-terminated polybutadiene having a number average molecular weight of 800 to 10000.

To minimize the residual isocyanate groups in the composition, it is preferred that the disappearance of the isocyanate groups is confirmed by an FT-IR or the like in the reaction. The terminal groups of thus obtained modified polyimide resin may be represented by the following formula (1-c) or the following formula (1-d).

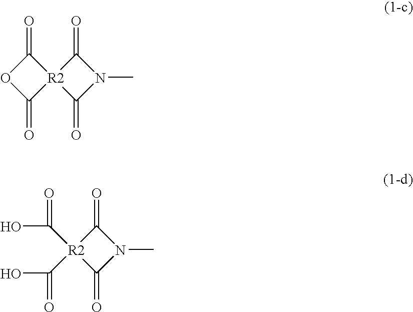

Symbols in the formulae (1-c) and (1-d) have the same meanings as those defined above.

In the production of the modified linear polyimide resin, a composition comprising a modified linear polyimide resin having a higher molecular weight can be obtained by reacting the polybutadiene diisocyanate composition and the tetracarboxylic acid dianhydride, followed by further reacting an additional diisocyanate compound therewith. In this case, the reaction ratio of the isocyanate compound is not particularly limited. When X represents the functional group equivalent of the isocyanate groups of the starting material diisocyanate compound, W represents the functional group equivalent of the hydroxyl groups of the starting material bifunctional hydroxyl-terminated polybutadiene, Y represents the functional group equivalent of the acid anhydride groups of the tetracarboxylic acid dianhydride, and Z represents the functional group equivalent of the isocyanate groups of the additional isocyanate compound, they preferably satisfy the relation of Y—(X—W)>Z≧0 (W>0, X>0, Y>0, Z>0).

The modified polyimide resin used in the present invention comprises two chemical structural units of the polybutadiene structure represented by the above formula (1-a) and the polyimide structure represented by the above formula (1-b). To make resin compositions flexible, in general, a rubber resin such as a polybutadiene resin is directly mixed with the resin composition. However, nonpolar rubber resins are liable to cause phase separation in highly polar thermosetting resin compositions. Particularly, when the content of the rubber resin is high, it is difficult to obtain a stable composition. Further, many of the resin compositions containing the rubber resin show insufficient heat resistance. To the contrary, polyimide resins are heat resistant and highly polar, to be relatively excellent in compatibility with thermosetting resin compositions. Because the modified linear polyimide resin used in the present invention has both of this polyimide structure and the polybutadiene structure that imparts flexibility within one molecule, a material that is excellent in both characteristics of flexibility and heat resistance can be provided. Additionally, favorable compatibility with the thermosetting resin also enables to provide a material that is suitable for forming a stable thermosetting resin composition.

In the modified polyimide resin used in the present invention, the composition ratio of the polybutadiene structure and the polyimide structure can be altered by controlling the reaction ratio of the starting materials. A high ratio of the polybutadiene structure makes the thermosetting resin composition of the invention be a material that is more excellent in flexibility, while a high ratio of the polyimide structure results in a material that is more excellent in heat resistance. As described above, when the content of the polybutadiene structure in the modified linear polyimide resin is less than 45% by weight, the flexibility of the modified linear polyimide resin tends to be poor. Therefore, in use for applications requiring flexibility such as flexible circuit boards and the like, the content of the polybutadiene structure is preferably 45% by weight or more. Also, it is known that compounds having a polybutadiene structure or a polyimide structure tend to have low dielectric constants and low dielectric loss tangent. The modified linear polyimide resin used in the present invention has both structures, whereby the thermosetting resin composition of the present invention is an insulating material that is also excellent in dielectric properties. Particularly, when the modified linear polyimide resin has a higher polybutadiene structure content, the thermosetting resin composition has further improved dielectric properties.

In component (a) of the bifunctional hydroxyl-terminated polybutadiene, which is used as a starting material for the modified polyimide resin in the invention, the term “bifunctional hydroxyl-terminated” means that the polybutadiene has hydroxyl groups at both of the terminal ends. An unsaturated bond within the molecule of the polybutadiene may be hydrogenated. Specific examples of the bifunctional hydroxyl-terminated polybutadienes include, e.g., G-1000, G-3000, GI-1000, and GI-3000 available from Nippon Soda Co., Ltd., and R-45EPI available from Idemitsu Kosan Co., Ltd., and the like.

Examples of the components (b) of the diisocyanate compounds, which are used as starting materials for the modified polyimide resin in the invention include diisocyanates such as toluene-2,4-diisocyanate, toluene-2,6-diisocyanate, hexamethylene diisocyanate, xylylene diisocyanate, diphenylmethane diisocyanate, and isophorone diisocyanate.

Specific examples of components (c) of the tetracarboxylic acid dianhydrides, which are used as starting materials for the modified polyimide resin in the invention include pyromellitic dianhydride, benzophenone tetracarboxylic dianhydride, biphenyl tetracarboxylic dianhydride, naphthalene tetracarboxylic dianhydride, 5-(2,5-dioxotetrahydrofuryl)-3-methyl-cyclohexene-1,2-dicarboxylic anhydride, 3,3′,4,4′-diphenylsulfone tetracarboxylic dianhydride, 1,3,3a,4,5,9b-hexahydro-5-(tetrahydro-2,5-dioxo-3-furanyl)-naphtho[1,2-C]furan-1,3-dione, and the like.

In the production of the modified polyimide resin in accordance with the present invention, the reaction between the bifunctional hydroxyl-terminated polybutadiene and the diisocyanate compound may be performed in an organic solvent under the conditions of a reaction temperature of 80° C. or lower and a reaction time of generally 1 to 8 hours. The reaction may be performed in the presence of a catalyst if necessary. The reaction between the polybutadiene diisocyanate composition and the tetracarboxylic acid dianhydride may be performed such that a solution containing the polybutadiene diisocyanate composition obtained following the reaction above is cooled to room temperature, the tetracarboxylic acid dianhydride is added to the solution, and they are reacted under the conditions of a reaction temperature of 120 to 180° C. and a reaction time of 2 to 24 hours. The reaction is generally performed in the presence of a catalyst. Further, an organic solvent may be added to the reaction system. Thus obtained reaction solution may be filtrated to remove insoluble substances, if necessary. In this manner, the modified linear polyimide resin composition can be obtained as a varnish. The solvent content of the varnish may be appropriately adjusted by controlling the solvent amount in the reaction or by adding a solvent after the reaction. Further, an additional diisocyanate may be reacted after the reaction between the polybutadiene diisocyanate composition and the tetracarboxylic acid dianhydride, to obtain a higher-molecular-weight modified linear polyimide resin. In this case, the additional diisocyanate compound may be added dropwise to the reaction mixture of the polybutadiene diisocyanate composition and the tetracarboxylic acid dianhydride, and reacted under conditions of a reaction temperature of 120 to 180° C. and a reaction time of 2 to 24 hours.

Examples of the organic solvents which may be used in the above each reaction include, e.g., polar solvents such as N,N′-dimethylformamide, N,N′-diethylformamide, N,N′-dimethylacetamide, N,N′-diethylacetamide, dimethylsulfoxide, diethylsulfoxide, N-methyl-2-pyrrolidone, tetramethylurea, γ-butyrolactone, cyclohexanone, diglyme, triglyme, carbitol acetate, propylene glycol monomethyl ether acetate, and propylene glycol monoethyl ether acetate. These solvents may be used in combination of two or more. Further, a nonpolar solvent such as an aromatic hydrocarbon may be optionally used in combination, if necessary.

Examples of the catalyst which may be used in the above each reaction include, e.g., tertiary amines such as tetramethylbutanediamine, benzyldimethylamine, triethanolamine, triethylamine, N,N′-dimethylpiperidine, α-methylbenzyldimethylamine, N-methylmorpholine and triethylenediamine; and organic metal catalysts such as dibutyltin laurate, dimethyltin dichloride, cobalt naphthenate, and zinc naphthenate; and the like. These catalysts may be used in combination of two or more. Particularly, the most preferred catalyst is triethylenediamine.

The thermosetting resin composition of the present invention comprises, as the main components, the above-described component (A) of the modified polyimide resin and the component (B) of at least one thermosetting resin selected from epoxy resins, bismaleimide resins, cyanate ester resins, bis-allyl-nadi-imide resins, vinylbenzyl ether resins, benzoxazine resins, and polymers of bismaleimide and diamine. Particularly preferred thermosetting resins are epoxy resins, which can be hardened at the lowest temperatures. Two or more types of the thermosetting resins may be mixed and used.

Examples of the epoxy resins include those having two or more functional groups in one molecule, such as, e.g., bisphenol A type epoxy resins, bisphenol F type epoxy resins, phenol novolac type epoxy resins, bisphenol S type epoxy resins, alkylphenol novolac type epoxy resins, biphenol type epoxy resins, naphthalene type epoxy resins, dicyclopentadiene type epoxy resins, epoxidation products derived from condensation products of phenol and aromatic aldehydes having a phenolic hydroxyl group, triglycidyl isocyanurate, and alicyclic epoxy resins. These epoxy resins may be used in combination of two or more.

When the epoxy resin is used, an epoxy curing agent is generally required. Examples of the epoxy curing agents include, e.g., amine-based curing agents, guanidine-based curing agents, imidazole-based curing agents, phenol-based curing agents, acid anhydride-based curing agents, epoxy adducts, and microencapsulation products thereof, and the like. Particularly, the amine-based curing agents and the imidazole-based curing agents are preferred from the viewpoint of the viscosity stability of the varnish of the resin composition. The epoxy curing agents may be used in combination of two or more. Additionally, a curing accelerator such as triphenylphosphine, phosphonium borate, 3-(3,4-dichlorophenyl)-1,1-dimethylurea or the like may be also used in combination.

Specific examples of the epoxy curing agents include, e.g., amine-based curing agents such as dicyandiamide; imidazole-based curing agents such as 2-phenyl-4-methyl-5-hydroxymethylimidazole and 2,4-diamino-6-[2′-methylimidazolyl-(1′)]-ethyl-s-triazine isocyanuric acid adducts; phenol-based curing agents such as triazine-structure-containing phenol novolac resins (e.g., PHENOLITE 7050 series available from Dainippon Ink and Chemicals, Inc.); and the like.

Examples of the bismaleimide resins include 4,4′-phenylmethane bismaleimide “BMI-S” available from Mitsui Chemicals, Inc., polyphenylmethane maleimide “BMI-M-20” available from Mitsui Chemicals, Inc., and the like.

Examples of the cyanate ester resins include bisphenol type cyanate esters such as “Primaset BA200” available from Lonza, Ltd., and “Primaset BA230S” available from Lonza, Ltd.; bisphenol H type cyanate esters such as “Primaset LECY” available from Lonza, Ltd., and “Arocy L10” available from Vantico Inc.; novolac type cyanate esters such as “Primaset PT30” available from Lonza, Ltd., and “Arocy XU371” available from Vantico Inc.; dicyclopentadiene type cyanate esters such as “Arocy XP71787 02L” available from Vantico Inc.; and the like.

Examples of the bis-allyl-nadi-imide resins include diphenylmethane-4,4′-bis(allylnadic)imide “BANI-M” available from Maruzen Petrochemical Co., Ltd., and the like.

Examples of the vinylbenzyl ether resins include V-1000X available from Showa Highpolymer Co., Ltd., those described in U.S. Pat. No. 4,116,936, U.S. Pat. No. 4,170,711, U.S. Pat. No. 4,278,708, JP-A-9-31006, JP-A-2001-181383, JP-A-2001-253992, JP-A-2003-277440, JP-A-2003-283076, WO 02/083610, and the like.

Examples of the benzoxazine resins include “B-a type benzoxazine” and “B-m type benzoxazine” available from Shikoku Corporation, and the like.

Examples of the thermosetting resins of the polymers of a bismaleimide compound and a diamine compound include “TECHMIGHT E2020” available from Printec Co., Ltd., and the like.

In the thermosetting resin composition of the present invention, the weight ratio (A):(B) between the component (A) and the component (B) is preferably within the range of 100:1 to 1:1. The total content of the component (A) and the component (B) of the thermosetting resin composition is preferably 70% by weight or more in the entire resin. When they are not within the range, the advantageous effects of the present invention may not be sufficiently obtained in some cases.

The thermosetting resin composition of the present invention may further comprise a filler, if necessary. The filler may be either an organic filler or an inorganic filler. Two or more fillers may be combined and used. The inorganic filler content is not particularly limited, but may be preferably added to fall within the range of 50% by weight or less in the thermosetting resin composition. When the content is more than 50% by weight, the thermosetting resin composition may be poor in laser processing properties, and the hardened material thereof becomes high in elastic modulus, rigid and brittle. Accordingly, such a material is not preferred and thereby unsuitable for flexible circuit boards.

Examples of the inorganic fillers include silicas, aluminas, barium sulfate, talcs, clays, mica powders, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate, and the like. Particularly preferred are silicas. The inorganic filler preferably has an average particle size of 5 μm or less. Examples of the organic fillers include acrylic rubber particles, silicon particles and the like. Also the organic filler preferably has an average particle size of 5 μm or less. The average particle sizes may be measured by a laser diffraction/scattering type particle size distribution measuring apparatus LA-500 manufactured by Horiba Ltd.

To the thermosetting resin composition of the present invention may be added various resin additives, resin components other than the components (A) and (B), and the like without departing from the scope in which the effects of the present invention can be achieved. Examples of the resin additives include thickeners such as Orben and Bentone; silicone-, fluorine-, or acryl-based antifoaming agents; leveling agents; adhesion imparting agents such as imidazole-, thiazole-, or triazole-based agents; surface treatment agents such as silane coupling agents; coloring agents such as phthalocyanine blue, phthalocyanine green, iodine green, disazo yellow, and carbon black; flame retardants such as phosphorus-containing compounds, bromine-containing compounds, aluminum hydroxide, and magnesium hydroxide; and oxidation inhibitors such as phosphorous-based oxidation inhibitors and phenol-based oxidation inhibitors.

The thermosetting resin composition of the present invention can be used in the form of an adhesive film comprising a thermosetting resin composition layer (a layer A) and a support film (a layer B), which is a suitable form for production of flexible circuit boards.

The adhesive film can be produced according to a method known to persons skilled in the art, for example, by dissolving the thermosetting resin composition of the present invention in an organic solvent to prepare a resin varnish, applying the resin varnish to the support film, and drying the organic solvent by heating or hot air blowing to form the thermosetting resin composition layer.

The support film (the layer B) acts as a support in the production of the adhesive film, and is finally peeled off or removed in the production of the flexible circuit board. Examples of the support films include, e.g., films of polyolefins such as polyethylenes and polyvinyl chlorides; films of polyesters such as polyethylene terephthalates (hereinafter may be referred to as “PET”) and polyethylene naphthalates; polycarbonates, as well as release papers, metal foils such as copper foils, and the like. Also, heat resistant resins such as polyimides, polyamides, polyamideimides and liquid crystal polymers can be used for the support film. When a copper foil is used as the support film, the copper foil can be removed by etching with an etching liquid of iron(II) chloride, copper(II) chloride or the like. The support film may be subjected to a mat treatment, a corona treatment, or a release treatment. It is more preferably subjected to a release treatment, in view of the peelable properties. Although the thickness of the support film is not particularly limited, it is generally 10 to 150 μm, and preferably within the range of 25 to 50 μm.

Examples of the organic solvents for preparing the varnish include, e.g., ketones such as acetone, methyl ethyl ketone, and cyclohexanone; acetate esters such as ethyl acetate, butyl acetate, cellosolve acetate, propylene glycol monomethyl ether acetate, and carbitol acetate; cellosolve; carbitols such as butyl carbitol; aromatic hydrocarbons such as toluene and xylene; dimethylformamide; dimethylacetamide; N-methylpyrrolidone; and the like. The organic solvents may be used in combination of two or more.

Although the drying conditions are not particularly limited, it is important to minimize the progress of hardening of the thermosetting resin composition as far as possible during the drying step to maintain the adhesive ability of the adhesive film. When a large amount of the organic solvent remains in the adhesive film, the organic solvent may cause blistering of the film after the hardening. Thus, the drying step is performed such that the organic solvent content of the thermosetting resin composition generally becomes 5% by weight or less, and preferably 3% by weight or less, based on the total weight of the thermosetting resin composition. Although specific drying conditions may vary depending on the hardening property of the thermosetting resin composition and the amount of organic solvent in the varnish, for example, a varnish containing 30 to 60% by weight of an organic solvent may be dried at 80 to 120° C. for 3 to 13 minutes. One skilled in the art can determine preferred drying conditions by simple experiments ad libitum.

The thermosetting resin composition which may be used in the thermosetting resin composition layer (the layer A) is as described above. The thickness of the thermosetting resin composition layer (the layer A) may be generally in the range of 5 to 500 μm. The preferred range of the thickness of the layer A may vary depending on the applications of the adhesive film. In a case where the adhesive film is used for producing a multilayer flexible circuit board by a build-up process, a conductor layer for forming a circuit generally has a thickness of 5 to 70 μm, whereby the layer A corresponding to an interlayer insulating layer preferably has a thickness within the range of 10 to 100 μm.

The layer A may be protected by a protective film. Protection by the protective film can prevent dust adhesion and scratching of the surface of the resin composition layer. The protective film is peeled off during the lamination process. The same material as the support film may be used for the protective film. The thickness of the protective film is not particularly limited, but preferably falls within the range of 1 to 40 μm.

The adhesive film of the present invention can be particularly preferably used for production of a multilayer flexible circuit board. A method for producing the multilayer flexible circuit board is described below. The adhesive film of the present invention can be preferably laminated to the flexible circuit board by a vacuum laminator. The flexible circuit board used herein may mainly comprise a substrate such as a polyester substrate, a polyimide substrate, a polyamideimide substrate, or a liquid crystal polymer substrate, and a patterned conductor layer (a circuit) formed on one or both sides of the substrate. Further, the flexible circuit board may be a multilayer flexible circuit board, which comprises alternately formed circuits and insulating layers and has circuits on one or both sides, and the adhesive film may be used for further increasing the layer number. It is preferred that surfaces of the circuits are roughened beforehand by a surface treatment agent such as hydrogen peroxide/sulfuric acid and MECetchBOND available from MEC Co., Ltd. from the viewpoint of adhesion of the insulating layer to the circuit board.

Examples of commercially available vacuum laminators include, e.g., a vacuum applicator manufactured by Nichigo-Morton Co., Ltd., a vacuum & pressure laminator manufactured by Meiki Co., Ltd., a roll type dry coater manufactured by Hitachi Industries Co., Ltd., a vacuum laminator manufactured by Hitachi AIC, Inc., and the like.

When the adhesive film has a protective film in the lamination process, the adhesive film is bonded to the circuit board by applying pressure and heat to the adhesive film after removing the protective film. In the lamination conditions, the adhesive film and the circuit board are preheated if necessary, and the bonding temperature is preferably 70 to 140° C. with the bonding pressure being preferably 1 to 11 kgf/cm² and the lamination is preferably performed under a reduced air pressure of 20 mmHg or less. The lamination may be achieved by a batch-wise method or a continuous roll method.

After the adhesive film is laminated to the circuit board, the adhesive film is cooled to around room temperature and the support film is peeled off. Then, the thermosetting resin composition laminated to the circuit board is thermally hardened. The conditions for thermal hardening are selected from the range of a temperature of 150 to 220° C. for a time of 20 to 180 minutes, in general, and more preferably selected from the range of a temperature of 160 to 200° C. for a time of 30 to 120 minutes. In case where the support film is release-treated or has a peelable layer such as silicon or the like, the support film may be peeled after the thermal hardening of the thermosetting resin composition or after the thermal hardening and hole forming.

After forming the insulating layer comprising the hardened material of the thermosetting resin composition, a hole such as a via hole and a through hole may be formed in the circuit board by a drill, a laser, a plasma, or a combination thereof as need. Particularly, a laser such as a carbon dioxide gas laser and a YAG laser may be generally used to form the hole.

Then, the insulating layer (the hardened material of the thermosetting resin composition) is subjected to a surface treatment. For the surface treatment, a method for a desmearing process may be employed, which may be performed simultaneously with desmearing. An oxidant is generally used as an agent for the desmearing process. Examples of the oxidants include, e.g., permanganate salts such as potassium permanganate and sodium permanganate, dichromate salts, ozone, hydrogen peroxide/sulfuric acid, nitric acid, and the like. Preferably, the treatment may be performed with an alkaline permanganate solution such as, e.g., an aqueous sodium hydroxide solution of potassium permanganate or sodium permanganate, which is widely used as an oxidant for roughening insulating layers in production of multilayer printed wiring boards by build-up processes. Prior to the treatment with the oxidant, the insulating layer may be treated with a swelling agent. After the treatment with an oxidant, the insulating layer is generally subjected to a neutralizing treatment with a reductant.

The desmearing process as described above can increase the peel strength of the conductor layer formed by plating, and thus may act also to roughen the insulating layer, thereby making the layer uneven, as the case may be. In general, the formation of an uneven surface is required for forming the conductor layer having a high peel strength on the insulating layer by plating. However, an uneven surface affects the accuracy of patterning the conductor into a circuit, and it is disadvantageously difficult to form a fine pattern with increasing the unevenness in order to increase the peel strength. When the thermosetting resin composition of the present invention contains substantially no filler, the cured material surface is not made uneven even though the surface treatment is effected using the above oxidant. However, according to the thermosetting resin composition of the present invention, even in cases where the conductor layer is formed on such a flat cured material surface by plating, the conductor layer has a high peel strength, and a finely patterned circuit can be formed with excellent adhesion. When the thermosetting resin composition of the present invention contains substantially no filler, the surface roughness (the Ra value) of the insulating layer can be 500 nm or less, still more preferably 400 nm or less, and yet more preferably 300 nm or less. The Ra value is an average height value calculated over the entire measurement region. Specifically, the Ra value is obtained by measuring and arithmetically averaging absolute height values from an average line surface in the measurement region, and can be represented by the following equation (1). In the equation, M and N represent a number of data in each direction of an array.

$$Ra = \frac{1}{MN} {\sum }_{k = 1}^{M} {\sum }_{j = 1}^{N} \vert {Z}_{jk} \vert \qquad ( 1 )$$

Specifically, a noncontact surface roughness meter WYKO NT3300 manufactured by Veeco Instruments Inc may be used to measure the surface roughness.

After the surface treatment, plating on the surface of the insulating layer forms the conductor layer. The conductor layer may be formed by a combined method of electroless plating and electroplating. Further, a plated resist inversely patterned with the conductor layer may be also formed, whereby the conductor layer may be form by only electroless plating. After forming the conductor layer, the peel strength of the conductor layer may be further improved and stabilized by annealing the layer at a temperature of 150 to 200° C. for 20 to 90 minutes.

The conductor layer may be subjected to a patterning processing to form the circuit by, for example, a subtractive process, a semi-additive process, or the like known to one skilled in the art. In the subtractive process, the thickness of the electroless-plated copper layer is 0.1 to 3 μm, and preferably 0.3 to 2 μm. The circuit board may be produced by forming an electroplated layer (a panel-plated layer), which has a thickness of 3 to 35 μm, preferably has a thickness of 5 to 20 μm, on the copper layer, followed by forming an etching resist, etching with an etching liquid of iron(II) chloride, copper(II) chloride or the like, and then forming a conductor pattern and peeling the etching resist. On the other hand, in the semi-additive process, the circuit board may be produced by forming an electroless-plated copper layer that has a thickness of 0.1 to 3 μm and preferably 0.3 to 2 μm, followed by forming a patterned resist, electroplating copper, and peeling the resist.

A film having a heat resistant resin layer (a heat resistant resin film) in place of the support film, i.e., a film comprising the thermosetting resin composition layer (the layer A) and a heat resistant resin layer (a layer C), can be used as a base film for a flexible circuit board. Also, a film comprising the thermosetting resin composition layer (the layer A), the heat resistant resin layer (the layer C), and a copper foil (a layer D) can be similarly used as a base film for a flexible circuit board. In this case, the base film has a layered structure comprising the layer A, the layer C, and the layer D in this order. The heat resistant resin layers of these base films are not peeled off and form a part of the flexible circuit board in cases of this type of base film.

A film comprising a heat resistant resin layer (a layer C) and an insulating layer (an layer A′) which comprises the hardened material of the thermosetting resin composition of the present invention formed thereon can be used as a base film for a single-sided flexible circuit board. Further, a film having a layered structure comprising the layer A′, the layer C, and the layer A′ in this order, and a film having a layered structure comprising the layer A′, the layer C and the copper foil (the layer D) in this order can be also used as a base film for a double-sided flexible circuit board in a similar manner.

Examples of heat resistant resins which may be used in the heat resistant resin layer include polyimide resins, aramid resins, polyamideimide resins, liquid crystal polymers, and the like. Particularly preferred are polyimide resins and polyamideimide resins. It is preferred that the heat resistant resin having a breaking strength of 100 MPa or more, a breaking extension of 5% or more, a thermal expansion coefficient of 40 ppm or less at 20 to 150° C., and a glass-transition temperature of 200° C. or higher or a decomposition temperature of 300° C. or higher is used in view of behavior in use in the flexible circuit boards.

Preferably used heat resistant resins having such properties may be film-shaped, commercially available and heat resistant resins, and known examples thereof include, e.g., a polyimide film “UPILEX-S” available from Ube Industries, Ltd., a polyimide film “KAPTON” available from Du Pont-Toray Co., Ltd., a polyimide film “APICAL” available from Kaneka Corporation, “ARAMICA” available from Teijin Advanced Films Ltd., a liquid crystal polymer film “VECSTAR” available from Kuraray Co., Ltd., a polyether ether ketone film “SUMILITE FS-1000C” available from Sumitomo Bakelite Co., Ltd., and the like.

The tensile breaking strength, the breaking extension, and the elastic modulus are determined according to a method described in JIS (Japanese Industrial Standards) K 7127. The thermal expansion coefficient and the glass-transition temperature are determined according to a method described in JIS K 7197. Also, in a case where the glass-transition temperature is higher than the decomposition temperature and is substantially not observed, the definition of “the glass-transition temperature of 200° C. or higher” is applied. The decomposition temperature is defined as a temperature at which mass reduction ratio measured according to a method described in JIS K 7120 is 5%.

The thickness of the heat resistant resin layer may be generally 2 to 150 μm and preferably is in the range of 10 to 50 μm. The heat resistant resin layer (the layer C) may be a surface-treated layer. Examples of the surface treatments include dry treatments such as mat treatments, corona discharge treatments, and plasma treatments; chemical treatments such as solvent treatments, acid treatments, and alkali treatments; sandblasting treatments; mechanical polishing treatments; and the like. It is particularly preferred that the heat resistant resin layer is subjected to a plasma treatment from the viewpoint of adhesion to the layer A.

The base film for a single-sided flexible circuit board, which comprises the insulating layer (A′) and the heat resistant resin layer (C), may be produced as follows. First, the thermosetting resin composition of the present invention is dissolved in an organic solvent to prepare a resin varnish in the same manner as the production of the above-described adhesive film, the resin varnish is applied to the heat resistant resin film, and the organic solvent is dried by heating or hot air blowing to form a thermosetting resin composition layer. The organic solvent, the drying conditions and the like are similar to those of the production of the above-described adhesive film. The thickness of the thermosetting resin composition layer preferably falls within the range of 5 to 15 μm.

Then, the thermosetting resin composition layer is thermally cured to form an insulating layer comprising a hardened material of the thermosetting resin composition. The conditions for thermal hardening are selected from the range of a temperature of 150 to 220° C. for a time of 20 to 180 minutes, in general, and more preferably selected from the range of a temperature of 160 to 200° C. for a time of 30 to 120 minutes.

The base film of the film for the double-sided flexible circuit board, which comprises three layers of the insulating layer (the layer A′), the heat resistant resin layer (the layer C), and the copper foil (the layer D), may be produced by forming the thermosetting resin composition into a layer on a copper-covered lamination film comprising the heat resistant resin layer (the layer C) and the copper foil (the layer D), and by the above procedures. The copper-covered lamination film may be a cast type two-layer CCL (Copper-clad laminate), a sputter type two-layer CCL, a laminate type two-layer CCL, a three-layer CCL, or the like. The thickness of the copper foil is preferably 12 μm or 18 μm.

Examples of commercially available two-layer CCL include ESPANEX SC (available from Nippon Steel Chemical Co., Ltd.), NEOFLEX I<CM> and NEOFLEX I<LM> (available from Mitsui Chemicals, Inc.), S'PERFLEX (available from Sumitomo Metal Mining Co., Ltd.) and the like, and examples of commercially available three-layer CCL include NIKAFLEX F-50VC1 (available from Nikkan Industries Co., Ltd.) and the like.

The base film of the film for the double-sided flexible circuit board, which comprises three layers of the insulating layer (the layer A′), the heat resistant resin layer (the layer C), and the insulating layer (the layer A′), may be produced as follows. First, in a similar manner to the production of the above adhesive film, the thermosetting resin composition of the present invention is dissolved in an organic solvent to prepare a resin varnish, the resin varnish is applied to the support film, and the organic solvent is dried by heating or hot air blowing to form the thermosetting resin composition layer. The organic solvent, the drying conditions and the like are similar to those of the production of the above-described adhesive film. The thickness of the thermosetting resin composition layer preferably falls within the range of 5 to 15 μm.

Then, the obtained adhesive films are laminated to both surfaces of the heat resistant resin film, respectively. The conditions of the lamination are similar to those described above. When the thermosetting resin composition layer is formed on one surface of the heat resistant film beforehand, the adhesive film may be laminated only to the other surface. Next, each thermosetting resin composition layer is thermally cured to form the insulating layer of the cured material of the thermosetting resin composition. The conditions for thermal curing are selected from the range of a temperature of 150 to 220° C. for a time of 20 to 180 minutes, in general, and more preferably selected from the range of a temperature of 160 to 200° C. for a time of 30 to 120 minutes.

A method for producing a flexible circuit board from the base film for the flexible circuit board is described below. As for the base film comprising the layer A′, the layer C, and the layer A′, after the thermal hardening first, a through hole is formed in a circuit board by a drill, a laser, a plasma or the like to achieve conduction between both surfaces. As for the base film comprising the layer A′, the layer C, and the layer D, a via hole is formed in a circuit board by a similar method. Particularly, a laser such as a carbon dioxide gas laser or a YAG laser may be generally employed to form the hole.

Then, the insulating layer i.e., the hardened material of the thermosetting resin composition, is subjected to a surface treatment. The surface treatment of the insulating layer may be similar to that of the adhesive film as described above. After conducting the surface treatment, plating on the surface of the insulating layer forms a conductor layer. The formation of the conductor by way of the plating may be performed in a similar manner to the adhesive film. After forming the conductor layer, the peel strength of the conductor layer may be further improved and stabilized by annealing the layer at a temperature of 150 to 200° C. for a time of 20 to 90 minutes.

Next, the conductor layer is subjected to a patterning processing to form the circuit thereby giving the flexible circuit board. When the base film comprising the layer A, the layer C, and the layer D is used, also the layer D of the copper foil is formed into a circuit. For example, a subtractive process, a semi-additive process or the like known to one skilled in the art may be employed to achieve the formation of each circuit. The details are the same as those of the aforementioned adhesive film.

Using the adhesive film of the present invention as described above, for example, a multilayer flexible circuit board can be produced through formation of multilayers with thus obtained single- or double-sided flexible circuit boards.

The thermosetting resin composition of the present invention is useful also as a material for forming a stress relaxation layer between a semiconductor and a substrate board (see, JP-A-2000-336271). For example, all or a part of an uppermost insulating layer on a substrate board may be formed by using the adhesive film of the present invention in a similar manner described above, and a semiconductor may be connected thereto to produce a semiconductor apparatus comprising the semiconductor and the substrate board bonded with the cured material of the thermosetting resin composition. In this case, the thermosetting resin composition layer of the adhesive film may have a thickness of within the range of 10 to 1000 μm selected ad libitum. Plating on the thermosetting resin composition of the present invention can form a conductor layer. Thus, a conductor layer can be easily formed by plating and patterned into a circuit also on the insulating layer for stress relaxation provided on the substrate board.

Other features of the invention will become apparent in the course of the following descriptions of exemplary embodiments which are given for illustration of the invention and are not intended to be limiting thereof.

### EXAMPLES

In the following Examples, the term “part(s)” means part(s) by weight.

### Production Example 1

### Production of Modified Linear Polyimide Resin (Modified Linear Polyimide Resin Varnish A)

In a reaction vessel, 50 g of G-3000 (a bifunctional hydroxyl-terminated polybutadiene, number average molecular weight=5047 (GPC method), hydroxyl equivalent=1798 g/eq., solid content=100% by weight, available from Nippon Soda Co., Ltd.); 23.5 g of IPSOL 150 (an aromatic hydrocarbon-based mixed solvent available from Idemitsu Kosan Co., Ltd.); and 0.005 g of dibutyltin laurate were mixed and dissolved uniformly. The uniform mixture was heated to 50° C., and 4.8 g of toluene-2,4-diisocyanate (isocyanate equivalent=87.08 g/eq.) was added thereto, and the resultant mixture was reacted for approximately 3 hours while stirring. The reaction mixture was subsequently cooled to room temperature, thereto were added 8.96 g of benzophenone tetracarboxylic dianhydride (acid anhydride equivalent=161.1 g/eq.), 0.07 g of triethylenediamine, and 40.4 g of ethyl diglycol acetate (available from Daicel Chemical Industries, Ltd.). The resultant mixture was heated to 130° C. while stirring and reacted for approximately 4 hours. Disappearance of the NCO peak at 2250 cm⁻¹ was observed by an FT-IR. When the disappearance of the NCO peak was confirmed and thus the reaction was considered completed, the reaction mixture was cooled to room temperature and filtered using a 100-mesh filter cloth to obtain a modified linear polyimide resin (a modified linear polyimide resin varnish A).

Properties of the modified linear polyimide resin varnish A:
Viscosity=7.5 Pa·s (25° C., E type viscometer)
Acid number=16.9 mgKOH/g
Solid content=50% by weight
Number average molecular weight=13723
Content of polybutadiene structure parts=50*100/(50+4.8+8.96)=78.4% by weight

### Production Example 2

### Production of Modified Linear Polyimide Resin (Modified Linear Polyimide Resin Varnish B)

In a reaction vessel, 50 g of G-3000 (a bifunctional hydroxyl-terminated polybutadiene, number average molecular weight=5047 (GPC method), hydroxyl equivalent=1798 g/eq., solid content=100% by weight, available from Nippon Soda Co., Ltd.); 23.5 g of IPSOL 150 (an aromatic hydrocarbon-based mixed solvent available from Idemitsu Kosan Co., Ltd.); and 0.007 g of dibutyltin laurate were mixed and dissolved uniformly. The uniform mixture was heated to 50° C., and 4.8 g of toluene-2,4-diisocyanate (isocyanate equivalent=87.08 g/eq.) was added thereto, and the resultant mixture was reacted for approximately 3 hours while stirring. The reaction mixture was subsequently cooled to room temperature, thereto were added 8.83 g of benzophenone tetracarboxylic dianhydride (acid anhydride equivalent=161.1 g/eq.), 0.07 g of triethylenediamine, and 74.09 g of ethyl diglycol acetate (available from Daicel Chemical Industries, Ltd.). The resultant mixture was heated to 130° C. while stirring and reacted for approximately 4 hours. When disappearance of the NCO peak at 2250 cm⁻¹ was confirmed by an FT-IR, 1.43 g of toluene-2,4-diisocyanate (isocyanate equivalent=87.08 g/eq.) was further added to the mixture, and the mixture was stirred to allow the reaction again at 130° C. for 2 to 6 hours while observing the disappearance of the NCO peak by the FT-IR. When the disappearance of the NCO peak was confirmed, the reaction was considered completed, and the reaction mixture was cooled to the room temperature and filtered using a 100-mesh filter cloth to obtain a modified polyimide resin (a modified linear polyimide resin varnish B). Properties of the modified linear polyimide resin varnish B:

Viscosity=7.0 Pa·s (25° C., E type viscometer)
Acid number=6.9 mgKOH/g
Solid content=40% by weight
Number average molecular weight=19890
Content of polybutadiene structure parts=50*100/(50+4.8+8.83+1.43)=76.9% by weight

### Example 1

40 parts of a component (A) of the modified linear polyimide resin varnish A obtained in Production Example 1, 8 parts of a component (B) of a bisphenol A type epoxy resin (epoxy equivalent: 185, “EPIKOTE 828” available from Japan Epoxy Resins Co., Ltd.), and 6.5 parts of a methyl ethyl ketone (hereinafter referred to as MEK) varnish of a triazine structure-containing phenol novolac resin (“PHENOLITE LA-7054” available from Dainippon Ink and Chemicals, Inc.) were mixed to prepare a varnish of a thermosetting resin composition. The thermosetting resin composition was subsequently applied by a die coater to a release-treated polyethylene terephthalate (hereinafter referred to as PET) film having a thickness of 38 μm such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition layer. The roll adhesive film was slit into a width of 507 mm to obtain a sheet-like adhesive film having a size of 507×336 mm.

### Example 2

40 parts of a component (A) of the modified linear polyimide resin varnish A obtained in Production Example 1, 3 parts of a component (B) of a bisphenol A type epoxy resin (epoxy equivalent: 185, “EPIKOTE 828” available from Japan Epoxy Resins Co., Ltd.), 9.1 parts of a biphenyl type epoxy resin (epoxy equivalent: 290, “NC-3000-H” available from Nippon Kayaku Co., Ltd.), 6.5 parts of a MEK varnish of a triazine structure-containing phenol novolac resin (“PHENOLITE LA-7054” available from Dainippon Ink and Chemicals, Inc.), and 3.9 parts of MEK were mixed to prepare a varnish of a thermosetting resin composition. Then, in the same manner as Example 1, the thermosetting resin composition was applied to a release-treated PET film by a die coater such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition layer. The roll adhesive film was slit into a width of 507 mm to obtain a sheet-like adhesive film having a size of 507×336 mm.

### Example 3

40 parts of a component (A) of the modified linear polyimide resin varnish A obtained in Production Example 1, 4 parts of a component (B) of a bisphenol A type epoxy resin (epoxy equivalent: 185, “EPIKOTE 828” available from Japan Epoxy Resins Co., Ltd.), 4.5 parts of a tetramethyl type, biphenol type epoxy resin (epoxy equivalent: 190, “YX-4000” available from Japan Epoxy Resins Co., Ltd.), and 6.5 parts of a MEK varnish of a triazine structure-containing phenol novolac resin (“PHENOLITE LA-7054” available from Dainippon Ink and Chemicals, Inc.) were mixed to prepare a varnish of a thermosetting resin composition. Then, in the same manner as Example 1, the thermosetting resin composition was applied to a release-treated PET film by a die coater such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition layer. The roll adhesive film was slit into a width of 507 mm to obtain a sheet-like adhesive film having a size of 507×336 mm.

### Example 4

40 parts of a component (A) of the modified linear polyimide resin varnish A obtained in Production Example 1, 4 parts of a component (B) of a bisphenol A type epoxy resin (epoxy equivalent: 185, “EPIKOTE 828” available from Japan Epoxy Resins Co., Ltd.), 4 parts of a triphenylmethane type polyfunctional epoxy resin (epoxy equivalent: 170, “EPPN-502H” available from Nippon Kayaku Co., Ltd.), 6.5 parts of a MEK varnish of a triazine structure-containing phenol novolac resin (“PHENOLITE LA-7054” available from Dainippon Ink and Chemicals, Inc.), and 1 part of MEK were mixed to prepare a thermosetting resin composition. Then, in the same manner as Example 1, the thermosetting resin composition was applied to a release-treated PET film by a die coater such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition. The roll adhesive film was slit into a width of 507 mm to obtain a sheet-like adhesive film having a size of 507×336 mm.

### Example 5

40 parts of a component (A) of the modified linear polyimide resin varnish A obtained in Production Example 1, 8 parts of a component (B) of a bisphenol A type epoxy resin (epoxy equivalent: 185, “EPIKOTE 828” available from Japan Epoxy Resins Co., Ltd.), 6.5 parts of a MEK varnish of a triazine structure-containing phenol novolac resin (“PHENOLITE LA-7054” available from Dainippon Ink and Chemicals, Inc.), 8 parts of a spherical silica (average particle size: 1.1 μm), and 4 parts of IPSOL 150 (an aromatic hydrocarbon-based mixed solvent available from Idemitsu Kosan Co., Ltd.) were mixed to prepare a thermosetting resin composition. Then, in the same manner as Example 1, the thermosetting resin composition was applied to a release-treated PET film by a die coater such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition. The roll adhesive film was slit into a width of 507 mm to obtain a sheet-like adhesive film having a size of 507×336 mm.

### Example 6

40 parts of a component (A) of the modified linear polyimide resin varnish A obtained in Production Example 1, 8 parts of a component (B) of a bisphenol A type epoxy resin (epoxy equivalent: 185, “EPIKOTE 828” available from Japan Epoxy Resins Co., Ltd.), 0.5 part of an imidazole-based curing agent (2,4-diamino-6-[2′-methylimidazolyl-(1′)]-ethyl-s-triazine isocyanuric acid adduct “CUREZOL 2MA-OK” available from Shikoku Corporation), 10 parts of a spherical silica (average particle size: 1.1 μm), and 4 parts of “IPSOL 150” (an aromatic hydrocarbon-based mixed solvent available from Idemitsu Kosan Co., Ltd.) were mixed to prepare a thermosetting resin composition. Then, in the same manner as Example 1, the thermosetting resin composition was applied to a release-treated PET film by a die coater such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition. The roll adhesive film was slit into a width of 507 mm to obtain a sheet-like adhesive film having a size of 507×336 mm.

### Example 7

40 parts of a component (A) of the modified linear polyimide resin varnish A obtained in Production Example 1, 8 parts of a component (B) of a bisphenol A type epoxy resin (epoxy equivalent: 185, “EPIKOTE 828” available from Japan Epoxy Resins Co., Ltd.), 0.5 part of a dicyandiamide (“EPICURE DICY7” available from Japan Epoxy Resins Co., Ltd.), 10 parts of a spherical silica (average particle size: 1.1 μm), and 4 parts of IPSOL 150 (an aromatic hydrocarbon-based mixed solvent available from Idemitsu Kosan Co., Ltd.) were mixed to prepare a thermosetting resin composition. Then, in the same manner as Example 1, the thermosetting resin composition was applied to a release-treated PET film by a die coater such that the composition had a resin thickness of 70 μm after drying. The applied composition was dried at 80 to 120° C. (100° C. on average) for 6 minutes to form a thermosetting resin composition layer having a residual solvent content of approximately 1% by weight, whereby an adhesive film was obtained. Then the adhesive film was wound into a roll while bonding a polypropylene film having a thickness of 15 μm to the surface of the thermosetting resin composition. The roll adhesive film was slit into a width of 507 mm to obtain a sheet-like adhesive film having a size of 507×336 mm.

The adhesive films obtained in Examples 1 to 7 were thermally cured at 180° C. for 90 minutes, respectively. The properties of each cured material of the thermosetting resin composition are shown in Table 1. The tensile breaking strengths were measured according to Japanese Industrial Standards (JIS) K7127. The dielectric properties were evaluated by a cavity resonance perturbation method using E8362B available from Agilent Technologies, Inc.

### Comparative Example 1

Further, a hardened material of Comparative Example 1 was produced by thermally hardening an interlayer insulating material of an epoxy resin (ABF-SHcode9K available from Ajinomoto Fine-Techno Co., Inc.) at 170° C. for 90 minutes, and the properties of the cured material are also shown in Table 1.

TABLE 1

| | | | | | | | | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 1 |
| Elastic | 11 | 20 | 20 | 15 | 35 | 23 | 21 | 3000 |
| modulus | | | | | | | | |
| (MPa) | | | | | | | | |
| Tensile | 11 | 12 | 8 | 8 | 14 | 13 | 14 | 70 |
| strength | | | | | | | | |
| (MPa) | | | | | | | | |
| Breaking | 67 | 44 | 41 | 46 | 37 | 59 | 62 | 6.7 |
| extension | | | | | | | | |
| (%) | | | | | | | | |
| Dielectric | 2.3 | 2.6 | 2.5 | 2.5 | 2.7 | 2.6 | 2.7 | 3.3 |
| constant | | | | | | | | |
| (1 GHz) | | | | | | | | |
| Dielectric | 0.010 | 0.010 | 0.011 | 0.013 | 0.013 | 0.012 | 0.011 | 0.031 |
| loss | | | | | | | | |
| tangent (1 GHz) | | | | | | | | |

### Example 8

### Production of Multilayer Flexible Circuit Board (No. 1)

A double-sided two-layer CCL comprising a copper foil having a thickness of 12 μm and a polyimide film having a thickness of 25 μm was formed into a circuit to prepare a circuit board having a through-hole with a diameter of 0.2 mm. The adhesive films obtained in Example 1 were laminated to both surfaces of the circuit board after peeling the polypropylene film from each adhesive film such that each thermosetting resin composition layer faced the circuit. Lamination was performed using a vacuum laminator manufactured by Meiki Co., Ltd. under the following conditions: a temperature of 130° C., a pressure of 7 kgf/cm², and an atmospheric pressure of 5 mmHg or less. Then, the release-treated PET films were peeled off, each thermosetting resin composition layer was thermally cured at 180° C. for 30 minutes to form an insulating layer, and a via-hole was formed by a laser. The surface treatment process of the insulating layer accompanied by a desmear process was performed using the following agents available from Atotech Japan: an oxidant “Concentrate Compact CP” (an alkaline permanganate solution); and a reductant “Reduction Solution Securiganth P-500.”

The insulating layer was subjected to a surface treatment with the oxidant solution at 80° C. for 10 minutes, and then to a neutralizing treatment with the reductant solution at 40° C. for 5 minutes. Then, an electroless copper plating catalyst was added to the surface of the insulating layer, and the resultant product was soaked in an electroless copper plating liquid at 32° C. for 30 minutes to form an electroless copper film having a thickness of 1.5 μm. This was dried at 150° C. for 30 minutes, acid-washed, and electro copper plated using an anode of a phosphorized copper plate under a cathode current density of 2.0 A/dm² for 12 minutes, to form a copper plating film. Thereafter, this was further annealed at 180° C. for 30 minutes. The thus-obtained conductor layer had a peel strength of 1.2 kgf/cm, which was measured according to JIS C6481, and the conductor plating had a thickness of about 30 μm.

### Example 9

### Production of Multilayer Flexible Circuit Board (No. 2)

A four-layer printed wiring board was produced using the adhesive film obtained in Example 5 in the same manner as Example 8. Thus obtained conductor layer had a peel strength of 0.8 kgf/cm.

### Example 10

### Production of Multilayer Flexible Circuit Board (No. 3)

A four-layer printed wiring board was produced using the adhesive film obtained in Example 6 in the same manner as Example 8. Thus obtained conductor layer had a peel strength of 1.0 kgf/cm.

### Example 11

### Production of Multilayer Flexible Circuit Board (No. 4)

A four-layer printed wiring board was produced using the adhesive film obtained in Example 7 in the same manner as Example 8. Thus obtained conductor layer had a peel strength of 0.9 kgf/cm.

### Example 12

### Production of Single-Sided Flexible Circuit Board

The thermosetting resin composition varnish described in Example 5 was applied to a polyimide film (25 μm) by a die coater such that it had a resin thickness of 10 μm after drying, and dried at 80 to 120° C. (100° C. on average) for 6 minutes to form a thermosetting resin composition layer having a residual solvent content of approximately 1% by weight, whereby a base film was prepared. Then the base film was wound into a roll while bonding a polypropylene film having a thickness of 15 μm to the surface of the thermosetting resin composition layer. The roll base film was slit into a width of 507 mm to obtain a sheet-like base film having a size of 507×336 mm. Subsequently, the polypropylene film was peeled from the base film, and the base film was thermally cured at 180° C. for 30 minutes to obtain a film for a flexible circuit board. Then, the resin layer was subjected to a surface treatment, electroless plated, and electroplated under the same conditions as in Example 8, to obtain a single-sided flexible circuit board. Thereafter, this was further annealed at 180° C. for 30 minutes. Thus obtained conductor layer had a peel strength of 0.8 kgf/cm, which was measured according to JIS C6481, and the conductor plating had a thickness of about 30 μm.

### Example 13

### Production of Double-Sided Flexible Circuit Board (No. 1)

The thermosetting resin composition varnish described in Example 5 was applied by a die coater to a polyimide surface of a single-sided two-layer CCL comprising a copper foil having a thickness of 12 μm and a polyimide film having a thickness of 25 μm such that it had a resin thickness of 10 μm after drying, and dried at 80 to 120° C. (100° C. on average) for 6 minutes to form a thermosetting resin composition layer having a residual solvent content of approximately 1% by weight. Then the resultant film was wound into a roll while bonding a polypropylene film having a thickness of 15 μm to the surface of the thermosetting resin composition. The roll base film was slit into a width of 507 mm to obtain a sheet-like film having a size of 507×336 mm. Subsequently, the polypropylene film was peeled from the sheet-like film, and the film was thermally cured at 180° C. for 30 minutes to obtain a film for a flexible circuit board. Then, the resin layer was subjected to a surface treatment, electroless plated, and electroplated under the same conditions as in Example 8, to obtain a double-sided flexible circuit board. Thereafter, this was further annealed at 180° C. for 30 minutes. Thus obtained conductor layer had a peel strength of 0.8 kgf/cm, which was measured according to JIS C6481, and the conductor plating had a thickness of about 30 μm.

### Example 14

### Production of Double-Sided Flexible Circuit Board (No. 2)

The thermosetting resin composition varnish described in Example 5 was applied by a die coater to a release-treated PET film such that it had a resin thickness of 10 μm after drying, and dried at 80 to 120° C. (100° C. on average) for 6 minutes to form a thermosetting resin composition layer having a residual solvent content of approximately 1% by weight, whereby an adhesive film was obtained. Then the resultant film was wound into a roll while bonding a polypropylene film having a thickness of 15 μm to the surface of the resin composition. The roll adhesive film was slit into a width of 507 mm to obtain a sheet-like adhesive film having a size of 507×336 mm. Subsequently, the adhesive films were laminated to both surfaces of a polyimide film having a thickness of 25 μm after peeling the polypropylene film from each adhesive film. Lamination was performed using a vacuum laminator manufactured by Meiki Co., Ltd. under the following conditions: a temperature of 130° C., a pressure of 7 kgf/cm² and an atmospheric pressure of 5 mmHg or less. Then, the release-treated PET films were peeled off, and the thermosetting resin composition was thermally cured at 180° C. for 30 minutes to obtain a film for a flexible circuit board. Thereafter, the surface of the hardened resin layer was roughened by a treatment with an alkaline oxidant of a permanganate salt, and electroless plated and electroplated to form a double-sided flexible circuit board. Thereafter, this was further annealed at 180° C. for 30 minutes. Thus obtained conductor layer had a peel strength of 0.8 kgf/cm, which was measured according to JIS C6481, and the conductor plating had a thickness of about 30 μm.

### Comparative Example 2

A four-layer printed wiring board was produced using an interlayer insulating material of an epoxy resin (ABF-SHcode9K available from Ajinomoto Fine-Techno Co., Inc.) in the same manner as Example 8. The surface treatment process of the insulating layer accompanied by a desmear process was performed using the following agents available from Atotech Japan: a swelling agent “Swelling Dip Securiganth P”, an oxidant “Concentrate Compact CP” (an alkaline permanganate solution), and a reductant “Reduction Solution Securiganth P-500.”

The insulating layer was subjected to a surface treatment with the swelling agent solution at 80° C. for 5 minutes, then to a surface treatment with the oxidant at 80° C. for 10 minutes, and finally to a neutralizing treatment with the reductant solution at 40° C. for 5 minutes. Thus obtained conductor layer had a peel strength of 1.0 kgf/cm.

Evaluation of Insulating Layer Surface.

The insulating layer surfaces of Examples 8, 9, 10, and 11, and Comparative Example 2 were observed by SEM after the surface treatments using the oxidant. It is elucidated from the SEM micrograph observation results that, by plating, the conductor layer was formed on a flat surface in Example 8 and the conductor layer was formed on a roughened surface in Examples 9, 10, and 11, and Comparative Example 2. Table 2 shows the results of measuring the surface roughness (the Ra value) of each insulating layer by a noncontact surface roughness meter (WYKO NT3300 manufactured by Veeco Instruments Inc.) after the surface treatment with the oxidant.

TABLE 2

| | | | Example | Example | Comparative |
|---|---|---|---|---|---|
| Samples | Example 8 | Example 9 | 10 | 11 | Example 2 |
| Surface | 254 | 540 | 699 | 327 | 950 |
| roughness | | | | | |
| (nm) | | | | | |

### INDUSTRIAL APPLICABILITY

The hardened material of the thermosetting resin composition according to the present invention is excellent in flexibility, mechanical strength, and dielectric properties. Further, a conductor layer with excellent adhesiveness can be readily formed on the hardened material surface by plating, whereby the hardened material can be preferably used as an insulating material of a flexible circuit board, particularly a multilayer flexible circuit board. Moreover, even where the hardened material does not have an uneven surface, a conductor layer having a high peel strength can be formed thereon. Thus, the thermosetting resin composition of the present invention can be preferably used for a flexible circuit board requiring formation of a fine pattern circuit.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A thermosetting resin composition, comprising:
(A) at least one modified linear polyimide resin obtained by reacting a bifunctional hydroxyl-terminated polybutadiene, a diisocyanate compound and a tetracarboxylic acid anhydride; and
(B) at least one thermosetting resin selected from the group consisting of an epoxy resin, a bismaleimide resin, a cyanate ester resin, a bis-allyl-nadi-imide resin, a vinylbenzyl ether resin, a benzooxazine resin, a polymer of bismaleimide and diamine, and mixtures thereof.

2. The thermosetting resin composition according to claim 1, wherein said modified linear polyimide resin (A) is a modified linear polyimide resin obtained by reacting a bifunctional hydroxyl-terminated polybutadiene and a diisocyanate compound I relative amounts such that the functional group equivalent ratio of the isocyanate groups of said diisocyanate compound to the hydroxyl groups of said bifunctional hydroxyl-terminated polybutadiene is greater than 1, to obtain a polybutadiene diisocyanate composition and by reacting said polybutadiene diisocyanate composition with a tetracarboxylic acid dianhydride.

3. The thermosetting resin composition according to claim 1, wherein said modified linear polyimide resin (A) is a modified linear polyimide resin obtained by reacting a bifunctional hydroxyl-terminated polybutadiene and a diisocyanate compound in relative amounts such that the functional group equivalent ratio of the isocyanate groups of said diisocyanate compound to the hydroxyl groups of said bifunctional hydroxyl-terminated polybutadiene is 1:1.5 to 1:2.5 to obtain a polybutadiene diisocyanate composition and by reacting said polybutadiene diisocyanate composition with a tetracarboxylic acid dianhydride.

4. The thermosetting resin composition according to claim 1, wherein said modified linear polyimide resin (A) is a modified linear polyimide resin obtained by reacting a bifunctional hydroxyl-terminated polybutadiene and a diisocyanate compound in relative amounts such that the functional group equivalent ratio of the isocyanate groups of said diisocyanate compound to the hydroxyl groups of said bifunctional hydroxyl-terminated polybutadiene is 1:1.5 to 1:2.5 to obtain a polybutadiene diisocyanate composition and by reacting said polybutadiene diisocyanate composition with a tetracarboxylic acid dianhydride at a ratio such that the functional group equivalent X of the isocyanate groups of the starting material diisocyanate compound, the functional group equivalent W of the hydroxyl groups of the starting material bifunctional hydroxyl-terminated polybutadiene, and the functional group equivalent Y of the acid anhydride groups of said tetracarboxylic acid dianhydride satisfy the relation of Y>X—W≧Y/5 (W>0, X>0, Y>0).

5. The thermosetting resin composition according to claim 1, wherein said modified linear polyimide resin (A) is a further modified linear polyimide resin obtained by reacting a bifunctional hydroxyl-terminated polybutadiene, a first diisocyanate compound, and a tetracarboxylic acid anhydride, to obtain a modified linear polyimide resin and then further reacting said modified linear polyimide resin with an additional isocyanate compound in a ratio such that the functional group equivalent X of the isocyanate groups of said first diisocyanate compound, the functional group equivalent W of the hydroxyl groups of said bifunctional hydroxyl-terminated polybutadiene, the functional group equivalent Y of the acid anhydride groups of said tetracarboxylic acid dianhydride, and the functional group equivalent Z of isocyanate groups of said additional isocyanate compound satisfy the relation of Y—(X—W)>Z≧0 (W>0, X>0, Y>0, Z>0).

6. A thermosetting resin composition, comprising:
(A) at least one modified linear polyimide resin having a polybutadiene structure represented by the following formula (1-a) and a polyimide structure represented by the following formula (1-b) within a molecule: 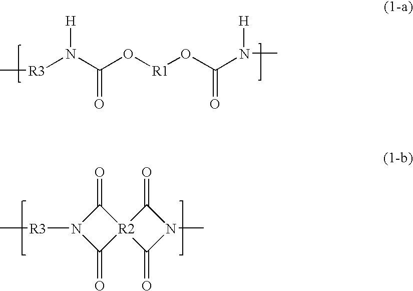
wherein R1 represents a residue obtained by removing hydroxyl groups from a bifunctional hydroxyl-terminated polybutadiene; R2 represents a residue obtained by removing acid anhydride groups from a tetracarboxylic acid dianhydride; and R3 represents a residue obtained by removing isocyanate groups from a diisocyanate compound, and
(B) at least one thermosetting resin selected from the group consisting of an epoxy resin, a bismaleimide resin, a cyanate ester resin, a bis-allyl-nadi-imide resin, a vinylbenzyl ether resin, a benzooxazine resin, a polymer of bismaleimide and diamine, and mixtures thereof.

7. The thermosetting resin composition according to claim 1, wherein the content of polybutadiene structure in the modified linear polyimide resin (A) is 45% by weight or more.

8. The thermosetting resin composition according to claim 1, wherein the content of polybutadiene structure in the modified linear polyimide resin (A) is 60% by weight or more.

9. The thermosetting resin composition according to claim 1, wherein R1 represents a residue obtained by removing hydroxyl groups from a bifunctional hydroxyl-terminated polybutadiene having a number average molecular weight of 800 to 10000.

10. The thermosetting resin composition according claim 1, wherein a hardened material of said thermosetting resin composition has an elastic modulus of 100 MPa or less, and a breaking extension of 20% or more.

11. The thermosetting resin composition according claim 1, wherein the composition ratio of component (A) and component (B) is 100:1 to 1:1 by weight, and the total content of component (A) and component (B) in the thermosetting resin composition is 70% by weight or more.

12. The thermosetting resin composition according claim 1, which further comprises a filler.

13. The thermosetting resin composition according to claim 1, wherein said thermosetting resin (B) comprises an epoxy resin.

14. The thermosetting resin composition according to claim 13, which further comprises an epoxy curing agent.

15. An adhesive film, comprising:
(A) a thermosetting resin composition layer, which comprises a thermosetting resin composition according to claim 1; and
(B) a support film,
wherein said thermosetting resin composition layer (A) is formed on said support film (B).

16. An adhesive film, comprising:
(A) a thermosetting resin composition layer, which comprises a thermosetting resin composition according to claim 1; and
(B) a support film subjected to a release treatment and having a release-treated surface,
wherein said thermosetting resin composition layer (A) is formed on said release-treated surface of said support film (B).

17. A flexible circuit board, comprising a circuit formed on a cured material of a thermosetting resin composition according to claim 1.

18. A multilayer flexible circuit board produced by a method comprising:
(1) laminating one or both sides of a flexible circuit board with an adhesive film according to claim 15;
(2) thermally curing said thermosetting resin composition layer (A) to form an insulating layer;
(3) forming a hole in said flexible circuit board;
(4) subjecting said insulating layer to a surface treatment, to obtain a surface-treated insulating layer;
(5) forming a conductor layer by plating on said surface-treated insulating layer; and
(6) forming said conductor layer into a circuit on said surface-treated insulating layer,
wherein said support film (B) is removed either:
(i) between said laminating and said thermally curing;
(ii) between said thermally curing and said forming a hole; or (iii) between said forming a hole and said subjecting said insulating layer to a surface treatment.

19. A multilayer flexible circuit board produced by a method comprising:
(1) laminating one or both sides of a flexible circuit board with an adhesive film according to claim 16;
(2) thermally curing said thermosetting resin composition layer (A) to form an insulating layer;
(3) forming a hole in said flexible circuit board;
(4) subjecting said insulating layer to a surface treatment, to obtain a surface-treated insulating layer;
(5) forming a conductor layer by plating on said surface-treated insulating layer; and
(6) forming said conductor layer into a circuit on said surface-treated insulating layer,
wherein said support film (B) is removed either:
(i) between said laminating and said thermally curing;
(ii) between said thermally curing and said forming a hole; or (iii) between said forming a hole and said subjecting said insulating layer to a surface treatment.

20. A film for a flexible circuit board, comprising:
(A′) an insulating layer, which comprises a cured material of a thermosetting resin composition according to claim 1; and
(C) a heat resistant resin layer,
wherein said insulating layer (A) is formed on said heat resistant resin layer (C).

21. A single-sided flexible circuit board, which is obtained by subjecting said insulating layer (A′) of a film for a flexible circuit board according to claim 20 to a surface treatment, to obtain a surface-treated insulating layer, forming a conductor layer by plating on said surface-treated insulating layer, and forming said conductor layer into a circuit.

22. A film for a flexible circuit board, comprising:
(A′) an insulating layer, which comprises a cured material of a thermosetting resin composition according to claim 1;
(C) a heat resistant resin layer; and
(D) a copper foil,
wherein said film has a layered structure in the order of said insulating layer (A′), said heat resistant resin layer (C), and said copper foil (D).

23. A double-sided flexible circuit board, which is obtained by forming a hole in a film for a flexible circuit board according to claim 22, subjecting said insulating layer (A′) to a surface treatment, to obtain a surface-treated insulating layer, forming a conductor layer by plating on a surface of said surface-treated insulating layer, and forming said conductor layer and said copper foil (D) into a circuit.

24. A film for a flexible circuit board, comprising:
(A′) a first insulating layer, which comprises a cured material of a thermosetting resin composition according to claim 1;
(C) a heat resistant resin layer; and
(A″) a second insulating layer, which comprises a cured material of a thermosetting resin composition according to claim 1,
wherein said film has a layered structure in the order of said first insulating layer (A′), said heat resistant resin layer (C) layer, and said second insulating layer (A″).

25. A double-sided flexible circuit board, which is obtained by forming a hole in said film for a flexible circuit board according to claim 24, subjecting said first insulating layer (A′) and said second insulating layer (A″) to a surface treatment, to obtain first and second surface-treated insulating layers, forming first and second conductor layers by plating on said first and second surface-treated insulating layers, and forming said first and second conductor layer into circuits.

26. A semiconductor apparatus, comprising a semiconductor and a substrate board, which are bonded with a cured material comprising a thermosetting resin composition according to claim 1.

27. A method of making a multilayer flexible circuit board, said method comprising:
(1) laminating one or both sides of a flexible circuit board with an adhesive film according to claim 15;
(2) thermally curing said thermosetting resin composition layer (A) to form an insulating layer;
(3) forming a hole in said flexible circuit board;
(4) subjecting said insulating layer to a surface treatment, to obtain a surface-treated insulating layer;
(5) forming a conductor layer by plating on said surface-treated insulating layer; and
(6) forming said conductor layer into a circuit on said surface-treated insulating layer,
wherein said support film (B) is removed either:
(i) between said laminating and said thermally curing;
(ii) between said thermally curing and said forming a hole; or (iii) between said forming a hole and said subjecting said insulating layer to a surface treatment.

28. A method of making a multilayer flexible circuit board, said method comprising:
(1) laminating one or both sides of a flexible circuit board with an adhesive film according to claim 16;
(2) thermally curing said thermosetting resin composition layer (A) to form an insulating layer;
(3) forming a hole in said flexible circuit board;
(4) subjecting said insulating layer to a surface treatment, to obtain a surface-treated insulating layer;
(5) forming a conductor layer by plating on said surface-treated insulating layer; and
(6) forming said conductor layer into a circuit on said surface-treated insulating layer,
wherein said support film (B) is removed either:
(i) between said laminating and said thermally curing;
(ii) between said thermally curing and said forming a hole; or (iii) between said forming a hole and said subjecting said insulating layer to a surface treatment.
